(19) United States
(12) Patent Application Publication
(10) Pub. No.: US 2008/0011174 A1
(43) Pub. Date: Jan. 17, 2008

(54) PRINTING PLATE MATERIAL, MANUFACTURING METHOD OF THE SAME, AND PLATE-MAKING METHOD USING THE SAME

(75) Inventors: Chiaki OHIGASHI, Kanagawa (JP); Shigeru IEMURA, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/753,099

(22) Filed: May 24, 2007

(30) Foreign Application Priority Data
Jul. 13, 2006 (JP) 2006-192335
Oct. 19, 2006 (JP) 2006-285533

(51) Int. Cl. B41C 3/08

(52) U.S. Cl. 101/401.1

(57) ABSTRACT

A printing plate material for direct plate-making includes a PET film base material; a protective layer and a photocatalytic hydrophilic layer provided on the base material; and a dot control layer provided on the hydrophilic layer and having a critical surface tension equal to or lower than a surface tension of an image forming liquid. The image forming liquid is discharged from an inkjet recording head onto a surface of the printing plate material for direct plate-making and is hardened. Thereby, a direct-made printing plate is obtained.

### BACKGROUND OF THE INVENTION

1. Field of the Invention

The present invention relates to a printing plate material for direct plate-making, a manufacturing method of the same, and a method for making a direct-made printing plate using the same, the direct-made printing plate being made of the printing plate material for direct plate-making, on which an image forming liquid is selectively discharged according to a predetermined image pattern, and thereby an image portion is formed.

2. Description of Related Art

Conventional planographic printing employs an aluminum-based PS plate provided with a photosensitive resin layer (an image forming layer) evenly coated on a surface thereof. Making a printing plate using such a PS plate generally includes a number of processes, including an image forming process, a developing process, a washing process, a gumming process, a drying process, and the like (e.g., Related Art 1). In the image forming process, the PS plate is exposed to a laser according to a predetermined image pattern, so that an image portion is selectively hardened. The developing process develops the image using a developer. The washing process washes away the developer, an unnecessary photosensitive resin, and the like. The gumming process applies a liquid containing gum arabic, a starch derivative, or the like, in order to protect the surface of the PS plate.

Instead of the above-described plate-making method, recently proposed are a variety of technologies related to a method for making an offset printing plate in an inkjet system, which requires no such processes of developing, washing, and the like. Such a printing plate is referred to as a direct-made printing plate. For instance, Related Art 2 discloses a technology relating to a printing plate material for direct-made planographic printing which is provided with an image receptive layer on a water-resistant base, the layer containing inorganic pigment and hydrophilic resin. The inorganic pigment contains silica particles having an average grain size of 1 μm to 6 μm and inorganic pigment ultrafine particles having an average grain size of 5 nm to 50 nm, at a weight ratio of between 40 and 70 to between 60 and 30. The hydrophilic resin is modified by at least one polar functional group, which is selected from a carboxyl group, a sulfone group, and a phosphono group.

Related Art 3 discloses a printing plate material in order to provide a printing plate material and a printing plate which are provided with a hydrophilic layer having scratch resistance and rubbing resistance to rubber equal to those of grained aluminum, and achieving an excellent printing durability. The hydrophilic layer provided on a base material of the printing plate material has a center line average roughness Ra of 150 nm or more and less than 1,000 nm, and an effective protrusion (protrusion from a plane higher than a center roughness plane by 1.0 μm in a three-dimensional roughness curved surface) of 500 or more and less than 3,000 per 1 mm².

Related Art 4 discloses a method for improving printing performance in an inkjet system when directly printing on material excluding paper or fabric, such as rubber, synthetic resin, metal, processed paper, and the like, by optimizing a physical property to ink of the material to be printed. Disclosed technology is, for example, to increase wettability of the material surface against the ink (a surface energy of about 50 dyn/cm to 100 dyn/cm) and to control a surface roughness Hmax of the printed material to about 1 μm to 5 μm.

However, the technologies above cannot provide a printing plate having an excellent printing durability and a high resolution used for the inkjet system. The technology disclosed in Related Art 2, for instance, has a problem where the hydrophilic image receptive layer peels off during printing when adhesion thereof to the water-resistant base is weak. In the technology disclosed in Related Art 3, when an image forming liquid having surface energy equivalent to that of water-based ink is used for image forming, the image forming liquid may bleed due to the hydrophilic property on the surface, thus incapable of forming a high-resolution image. Further, the adhesion between the image forming liquid and the hydrophilic layer may be weak due to small average roughness, thus possibly leading to a substantially low printing durability. The technology disclosed in Related Art 4 intends to improve the printing performance by optimizing the printed material originally having a water-shedding property, but does not improve a printing plate or a printing plate material provided with a hydrophilic layer having a water retention capability on a surface thereof and with a function to prevent ink spread.
[Related Art 1] Japanese Patent Laid-open Publication H10-83082
[Related Art 2] Japanese Patent Laid-open Publication 2001-10246
[Related Art 3] Japanese Patent Laid-open Publication 2003-231374
[Related Art 4] Japanese Patent Laid-open Publication H10-235989

As described above, the conventional printing plate materials and the plate-making methods using the same have the problems where it is difficult to provide a printing plate having printability represented as printing durability and dampening water retainability, and, at the same time, achieving a high-resolution image portion.

### SUMMARY OF THE INVENTION

The present invention is provided to address the problems in the conventional arts. The present invention provides a printing plate material for direct plate-making on which an image forming liquid is discharged and directly attached to the printing plate material so as to form an image portion; the printing plate material achieving high resolution while having a relatively simple structure, having excellent printability and printing durability, and being used as a direct-made printing plate. The present invention further provides a manufacturing method of the printing plate material for direct plate-making and a method for making a direct-made printing plate using the printing plate material for direct plate-making.

The present invention has been achieved based on the inventors' keen examination focusing on a relationship between surface tension of an image forming liquid and critical surface tension of a printing plate material for direct plate-making. More specifically, the above-described purpose is achieved with a printing plate material for direct plate-making as described below in (1) to (15).

(1) A printing plate material on which an image forming liquid is applied, the printing plate material comprising, a base material, a dot control layer that has a critical surface tension equal to or lower than a surface tension of the image forming liquid, a hydrophilic layer that is provided between said base material and said dot control layer, said hydrophilic layer comprising a photocatalyst that induces hydrophilization when exposed to light, and a protective layer that is provided between said base material and said hydrophilic layer, said protective haler containing inorganic material.

(2) The printing plate material according to (1), wherein said base material comprises paper.

(3) The printing plate material according to (1), wherein said base material comprises resin.

(4) The printing plate material according to one of (1) to (3), wherein said hydrophilic layer comprises titanium oxide.

(5) The printing plate material according to one of (1) to (4), wherein said hydrophilic layer has an average thickness in the range of about 0.01 μm to about 1 μm.

(6) The printing plate material according to (1), wherein said hydrophilic layer is porous, has a porosity in the range of about 60% to about 80%, and has a thickness in the range of about 3 μm to about 10 μm.

(7) The printing plate material according to one of (1) to (6), wherein said dot control layer comprises a water-soluble material.

(8) The printing plate material according to one of (1) to (7), wherein a contact angle of said dot control layer and the image forming liquid is in the range of about 30 degrees to about 70 degrees.

(9) The printing plate material according to one of (1) to (8), wherein said dot control layer has a water-soluble surfactant having a surface tension of about 20 mN/m or lower at a temperature of 25 degrees Celsius in a water solution having 0.1% by weight.

(10) The printing plate material according to one of (1) to (9), wherein said dot control layer includes a fluorosurfactant.

(11) The printing plate material according to one of (1) to (10), wherein said base material comprises paper on which one of polyethylene terephthalate treatment and water resistance treatment is provided.

(12) The printing plate material according to one of (1) to (11), wherein a surface of said base material is roughened.

(13) The printing plate material according to one of (1) to (12), wherein said hydrophilic layer contains spacer particles, said spacer particles comprising inorganic material that roughens a surface of the printing plate material.

(14) The printing plate material according to one of (1) to (12), wherein said protective layer contains spacer particles, said spacer particles comprising the inorganic material that roughens the surface of the printing plate material.

(15) The printing plate material according to one of (1) to (5) and (7) to (14), wherein a surface of the printing plate material has a surface roughness parameter Ry defined in JIS B0601: 1994 in the range of about 8 μm to about 12 μm, and an average roughness parameter Ra defined in JIS B0601: 1994 in the range of about 1 μm to about 2 μm.

Further, the above-described purpose is achieved in a manufacturing method of the printing plate material for direct plate-making as described below in (16) to (19).

(16) A manufacturing method of a printing plate material comprising, forming a hydrophilic layer on a roughened surface of a base material, the base material comprising one of resin and paper, the hydrophilic layer comprising a photo catalyst that induces hydrophilization when exposed to light; and forming a dot control layer on a surface of the hydrophilic layer, the dot control layer having a critical surface tension equal to or lower than a surface tension of an image forming liquid to be applied to the printing plate.

(17) A manufacturing method of a printing plate material comprising, forming one of a roughened hydrophilic layer and a porous hydrophilic layer on a surface of a base material, the hydrophilic layer comprising a photo catalyst that induces hydrophilization when exposed to light; and forming a dot control layer on a surface of the hydrophilic layer, the dot control layer having a critical surface tension equal to or lower than a surface tension of an image forming liquid to be applied to the printing plate.

(18) A manufacturing method of a printing plate comprising, providing a protective layer on a surface of a base material, the protective layer comprising inorganic material, providing on the protective layer, a hydrophilic layer containing a photocatalyst that induces hydrophilization when exposed to light, exposing the hydrophilic layer including the photocatalyst to the light to hydrophilize the hydrophilic layer, and forming a dot control layer on a surface of the hydrophilic layer.

(19) The manufacturing method according to (18), further comprising forming the dot control layer by drying a coating film of an aqueous surfactant solution having surfactant in the range of about 0.2% by weight to about 0.8% by weight.

Further, the above-described purpose is achieved in a method for making a direct-made printing plate as described below in (20) to (21).

(20) A method for making a direct-made printing plate using a printing plate material according to (1), the plate-making method comprising, applying the image forming liquid onto a surface of the dot control layer, and hardening the image forming liquid by one of exposing the image forming liquid to the light and heating the image forming liquid.

(21) A method for making a direct-made printing plate using a printing plate material according to (1), the plate-making method comprising, applying an image forming liquid including a photopolymerized resin onto a surface of the dot control layer; and hardening the image forming liquid by exposing the image forming liquid to the light, and, at the same time, hydrophilizing the hydrophilic layer containing the photocatalyst by exposure to the light.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a structure of a printing plate material for direct plate-making having a roughened PET film base material;

FIG. 2 illustrates a structure of a printing plate material for direct plate-making having a roughened photocatalytic hydrophilic layer;

FIG. 3 illustrates a plate-making method using the printing plate material for direct plate-making according to the present invention;

FIG. 4 illustrates a plate-making method using the printing plate material for direct plate-making according to the present invention;

FIG. 5 illustrates a printing plate material for direct plate-making having a porous hydrophilic layer; and

FIG. 6 illustrates a plate-making method using the printing plate material for direct plate-making according to the present invention.

### DETAILED DESCRIPTION OF PREFERRED EMBODIMENTS

The embodiments of the present invention are explained in the following, with reference to the above-described drawings. A direct-made printing plate according to the embodiments of the present invention is an offset printing plate made directly from a draft without using a prepress film. A printing plate material for direct plate-making according to the embodiments of the present invention is a direct-made printing plate on which no image portion has been formed. In other words, forming an image portion on the printing plate material for direct plate-making makes the direct-made printing plate. A process for making the direct-made printing plate is referred to as plate-making.

Performance of the direct-made printing plate made as described above is determined based on a shape, peeling, and wear resistance of a dot (a droplet) of an image forming liquid for forming an image portion provided on a surface of the printing plate material for direct plate-making in the plate-making process; dampening water retainability on a non-image portion; and wear resistance on a surface of the non-image portion. Resolution of the direct-made printing plate is mainly affected by the shape (the diameter) of the dot (the droplet). Printing durability of the direct-made printing plate is mainly affected by the dot shape (height), peeling (adhesion), and wear resistance. Further, printability of the direct-made printing plate is mainly affected by the dampening water retainability on the non-image portion and the wear resistance on the non-image portion surface.

1. A Printing Plate Material for Direct Plate-Making:

As a film base material according to the embodiments of the present invention, a resin film or a paper is used. Examples of the resin film include polyethylene terephthalate, polyethylene naphtahalate, polycarbonate, polysulphone, polyimide, polyamide, polyphenylene oxide, and cellulosic ester films and other films. Particularly, the polyethylene terephthalate (PET) is preferable for easy availability and other reasons.

For the paper, a paper provided with water-resistance treatment can be used. Methods of the water-resistance treatment include adding an internal additive during a paper-making process; impregnating the paper base material with an agent for processing in a later process; and forming a film on the paper base material in a later process. Examples of the internal additive added during the paper-making process include polyvinyl alcohol resin, polyacrylamide, urea formaldehyde resin, melamine formaldehyde resin, dialdehyde, starch, polyamide polyamine, epichlorohydrin, and the like.

Examples of the agent for processing to impregnate the paper base material with in the later process include resin latex, such as SBR latex, vinyl acetate latex, vinyl chloride latex, vinylidene chloride latex, and the like.

Forming the film on the paper base material in the later process is to provide a film on a surface of the paper base material using material having water repellency or a waterproof property. Methods for forming the film include a roll coating method and a spraying method. Examples of an agent for processing used in the methods include a paraffin wax-based wax mixed with low-molecular polyethylene, ethylene-vinyl acetate copolymer, butyl rubber, and the like. Examples of an agent for processing other than the wax include a non-aqueous high polymer, such as a solution of polyvinyl chloride, polyvinylidene chloride, polyvinyl acetate, ethylene-vinyl acetate copolymer, vinylidene chloride-vinyl acetate copolymer, and the like; an emulsion; and the like. Using the materials above as the film base material provides an affordable printing plate.

The surface of the printing plate material for direct plate-making of the embodiments of the present invention may be roughened or formed so as to be porous. The surface roughness and porosity affect a shape and adhesion of a dot of an image forming liquid (hereinafter described) formed on the surface of the printing plate material for direct plate-making, and further a pressure exerted on the dot during printing. The surface roughness and porosity thus affect resolution and printing durability of a direct-made printing plate. The effects of the surface roughness and porosity are described below. Roughening means to form intrusions and extrusions on the surface of the printing plate material. Forming to be porous means to form a layer having numerous minute pores on the surface of the printing plate material. The dot means a droplet of an discharged image forming liquid formed on the surface of the printing plate material for direct plate-making.

Described first is a relationship between the surface roughness of the printing plate material for direct plate-making and the dot shape. Since the printing plate material for direct plate-making has an uneven surface having minute intrusions and extrusions formed thereon, an attached image forming liquid tends to spread along the intrusions due to capillary action. Thereby, the image forming liquid permeates in substantially a vertical direction with respect to the printing plate material for direct plate-making, that is, in a depth direction, before spreading in a horizontal direction with respect to the printing plate material for direct plate-making. The dot thus appears having a clear round shape from a top view of the printing plate material for direct plate-making. The dot is prevented from spreading, thus improving the resolution of the printing plate. Further, the image forming liquid adheres thinly to extruded portions and thickly to intruded portions on the surface. Thus, the dot of the image forming liquid formed on the printing plate material for direct plate-making has substantially a flat shape slightly protruding from the printing plate material for direct plate-making from a side view of the p plate. Such a dot shape reduces a force exerted on an image portion during printing, thus improving printing durability.

Described next is a relationship between the surface roughness of the printing plate material for direct plate-making and the dot adhesion. The adhesion between the dot and the printing plate material for direct plate-making is determined by 1) adhesion between the film base material and a hydrophilic layer (hereinafter described); 2) adhesion between the hydrophilic layer and a dot control layer (hereinafter described); and 3) adhesion between the dot control layer and an image forming liquid (hereinafter described). An additional factor that contributes to the adhesion of the dot and the printing plate material is the unevenness on the surface of the printing plate material for direct plate-making. When it is assumed that the adhesion is not affected by the surface unevenness, the adhesion of the dot and the printing plate material for direct plate-making should remain the same, as long as a combination of the hydrophilic layer, the dot control layer, and the image forming liquid is the same, and thus the adhesion described in 1) to 3) is the same, even though the surface unevenness changes. When the surface unevenness of the printing plate material for direct plate-making changes, however, the adhesion differs. The difference occurs since an anchor effect varies depending on the surface unevenness. More specifically, when the unevenness becomes large, an adhesion area in the same surface area widens, thus increasing the adhesion.

Similarly, a porous printing plate material for direct plate-making controls the dot shape exerting capillary action of micropores, which allows the attached liquid to permeate in the depth direction while preventing the spread in the horizontal direction with respect to the printing plate material. Further, the anchor effect of the micropores affects the dot adhesion.

1-1. A Method for Roughening the Printing Plate Material for Direct Plate-Making:

The printing plate material for direct plate-making can be roughened by 1) roughing the film base material and 2) providing a roughened hydrophilic layer.

1) When Roughing the Film Base Material:

For roughening the surface of the resin film base material, a sand-blasting method is known in which a fine abrasive is sprayed along with high-pressured air from a blast gun to the resin film for roughening. Additionally known roughening methods include coating with a polymer having particles added therein to form a resin film; pressuring a resin film surface using an embossed roll, which is a metal roll having an uneven pattern carved on a surface thereof, so as to transfer the pattern; and performing chemical treatment on a resin film surface portion.

A method for roughening the surface of the paper film material includes applying to the base surface a resin composition having an inorganic filler and a binder resin so as to form a minute uneven layer on the entire surface, and the like.

Any roughening technique, such as brush polishing and the like, may further be used, as far as the processing method can achieve a target surface roughness parameter and shape.

As described hereinafter, the printing plate material for direct plate-making includes the film base material, the hydrophilic layer, and the dot control layer. When roughening the surface of the film base material, it is preferable that the hydrophilic layer and the dot control layer be controlled to be thin enough to have no impact to the surface roughness. In this case, it is acceptable to consider that the surface roughness of the printing plate material for direct plate-making is the surface roughness of the film base material.

The surface roughness of the printing plate material for direct plate-making roughened as above is properly controlled based on the shape and adhesion of the dot of the discharged image forming liquid formed on the printing plate material for direct plate-making.

For the surface roughness of the printing plate material for direct plate-making, a preferable range of Ry is between 8 μm and 12 μm, inclusively, and that of Ra is between 1 μm and 2 μm, inclusively, Ry being a maximum depth as defined in JIS B0601 (1994), Ra being arithmetic average roughness as defined in JIS B0601 (1994). A more preferable range of Ry is between 9 μm and 10 μm, inclusively, and that of Ra is between 1 μm and 1.5 μm, inclusively. Thereby, the shape and adhesion of the dot of the image forming liquid discharged on the surface of the printing plate material is good. Particularly, the greater an Ry value is, the less a force is exerted on the dot, since such Ry functions as a spacer when an ink roller and the like and the printing plate contact during printing.

However, preferable surface roughness slightly changes depending on a droplet amount discharged from an inkjet recording head. For low-resolution recording, for instance, the droplet amount discharged from the inkjet recording head is large. Thus, the roughness parameters Ry and Ra need to be greater so as to reduce protrusion of the dot. On the other hand, for high-resolution recording, the droplet amount is small, and thus the roughness parameters Ry and Ra become less. As described above, the range of the surface roughness may be appropriately changed according to the droplet amount discharged from the inkjet recording head.

The printing plate material for direct plate-making of the embodiments of the present invention has the hydrophilic layer provided on the film base material. A configuration of the hydrophilic layer, which is provided in order to increase dampening water retainability during printing, is not limited as far as the layer has affinity for water. It is preferable, however, that the layer have a critical surface tension of 50 mN/m or higher, so as to maintain a good dampening water retainability during printing.

Such a hydrophilic layer includes a hydrophilic layer containing a photocatalyst that induces hydrophilization when being exposed to an active light (hereinafter referred to as a “photocatalytic hydrophilic layer”). The active light is a light that has a light emitting line in a wavelength range to which the photocatalyst is sensitive. Hydrophilization is an effect to increase affinity for water as the photocatalyst is exposed to the active light and thus a hydrophilic group is provided on a surface. Examples of the photocatalyst include titanium oxide, zinc oxide, and the like. The titanium oxide is preferable among others in terms of a level of photocatalytic performance.

In order to maintain mechanical strength of the photocatalytic hydrophilic layer, the titanium oxide and inorganic coating agent may be used together. The inorganic coating agent is a coating agent that contains a hydrolytic substance as a matrix, the hydrolytic substance being derived from hydrolysis of a hydrolytic organosilane, which is represented as a chemical formula of SiX₄ (X: a hydrolysis group). Further, the coating agent may also contain a metal fluoride filler whose surface is coated by silica. Such an inorganic coating agent has a characteristic of forming micropores. The pores formed herein may be independently existing cells or interconnected cells. The photocatalytic hydrophilic layer may have a structure where titanium oxide is dispersed in the inorganic coating agent. An example of a material having such a structure is “Frescera-P” of Matsushita Electric Works, Ltd., and the like.

The inorganic coating agent that contains titanium oxide is preferable since the agent can form a hydrophilic layer when being applied to the base material and dried. The agent is also excellent in life length, since the matrix is not decomposed when subject to a catalytic function of the titanium oxide.

The photocatalytic hydrophilic layer may be provided with a matrix in which the titanium oxide is dispersed, the matrix having a high binding energy and being unaffected by the catalytic function of the titanium oxide.

The titanium oxide has two types, anatase and rutile. Either of the types may be used, though the anatase-type titanium oxide is preferable. To further increase the photocatalytic performance, a preferable average grain size of the titanium oxide is 20 nm or smaller.

It is preferable to provide the photocatalytic hydrophilic layer on the roughened film base material. In order to avoid a substantial change in the surface roughness of the film base material and to completely cover the film base material, a preferable layer thickness is between 0.01 μm and 1 μm, inclusively. To prevent a crack, a more preferable thickness is between 0.01 μm and 0.5 μm, inclusively. The film thickness herein does not include the protective layer (hereinafter described), which is employed along with the photocatalytic hydrophilic layer. The photocatalytic hydrophilic layer obtained as described above has a contact angle of substantially 0 degrees with respect to water after being exposed to an active light, thus providing an excellent hydrophilic property.

Further, when the hydrophilic property declines, the photocatalytic hydrophilic layer can regain the property by reacting to ultraviolet that works as the active light. Using an ultraviolet hardening resin as the image forming liquid allows re-hydrophilization of the photocatalytic hydrophilic layer when being exposed to ultraviolet, which is irradiated in an image forming process for hardening the resin so as to form an image portion, thereby preventing a trouble during printing caused by a hydrophilic failure.

When the photocatalytic hydrophilic layer is used, the protective layer having an inorganic material needs to be provided between the film base material and the hydrophilic layer. The protective layer is provided in order to protect the film base material, which has an organic material, from decomposition caused by photocatalytic action. Preferable as a material for the protective layer is an inorganic coating agent being provided as the photocatalytic hydrophilic layer and having no titanium oxide. The material is capable of reinforcing the adhesion between the protective layer and the photocatalytic hydrophilic layer. The protective layer further prevents decomposition of the dot control layer caused by photocatalytic action of the photocatalytic hydrophilic layer. In addition to the above-described material, a variety of inorganic coating agents and inorganic coating materials may be used for the protective layer. A preferable thickness of the protective layer is between 0.1 μm and 0.5 μm, inclusively, so as to avoid a substantial change in the surface roughness of the film base material and to completely cover the film base material.

2) When Providing the Roughened Hydrophilic Layer:

For roughening the surface of the printing plate material for direct plate-making according to the embodiments of the present invention, the roughened photocatalytic hydrophilic layer can be provided on the film material base.

Providing the roughened photocatalytic hydrophilic layer means adding particles having a variety of sizes to the photocatalytic hydrophilic layer so as to form an uneven hydrophilic layer on the base material surface. More specifically, the surface of the printing plate material for direct plate-making is roughened by forming the photocatalytic hydrophilic layer or protective layer having spacer particles. The spacer particles may be added only to the photocatalytic hydrophilic layer, only to the protective layer, or to the both layers.

The spacer particles are particles added in order to form the uneven photocatalytic hydrophilic layer or protective layer on the film base material, and eventually to roughen the surface of the printing plate material for direct plate-making. For example, when the spacer particles are added only to the protective layer, the protective layer having intrusions and extrusions is provided on the film base material. The photocatalytic hydrophilic layer is further provided thereon without filling the intrusions and extrusions, and eventually the printing plate material for direct plate-making is provided with a roughened surface. The surface of the printing plate material for direct plate-making can be roughened in a similar manner when the spacer particles are added only to the photocatalytic hydrophilic layer, and when added to both the protective layer and photocatalytic hydrophilic layer. Selecting an appropriate particle size for use achieves a target surface roughness. For the surface roughness, as described earlier, a preferable range of Ry is between 8 μm and 12 μm, inclusively, and that of Ra is between 1 μm and 2 μm, inclusively; and a more preferable range of Ry is between 9 μm and 10 μm, inclusively, and that of Ra is between 1 μm and 1.5 μm, inclusively.

A material of the spacer particles is not particularly limited. It is preferable, however, to use an inorganic material since the material is less affected by decomposing action of the photocatalyst. More specifically, a filler can be used, such as alumina, silica, and the like, which is generally used as a filler of resin and the like. The inorganic material provides a further improved affinity for the photocatalytic hydrophilic layer or the protective layer, when an inorganic coating agent is used for the photocatalytic hydrophilic layer or the protective layer.

The above-described method for roughening the surface of the printing plate material for direct plate-making has an advantage of eliminating a process for roughening the film base material, thereby simplifying a manufacturing process of the printing plate material. Of course, the photocatalytic hydrophilic layer or protective layer having the spacer particles can be provided on the roughened film base material. The method is advantageous in that the surface of the printing plate material can be roughened in more complex shape.

1-2. A Method for Providing the Porous Printing Plate Material for Direct Plate-Making:

The printing plate material for direct plate-making may be roughened by providing a porous hydrophilic layer. The porous hydrophilic layer has numerous minute pores therein. A preferable porosity is between 60% and 80%, inclusively. The porosity can be calculated in the following method:
1) A sampled piece for measuring the porosity is weighed;
2) The sample piece is immersed in a non-volatile solution, such as silicon oil, for 2 to 3 minutes;
3) The sampled piece after the immersion is weighed; and
4) The porosity is calculated with the following formula:

Porosity=(Weight difference between before and after immersion/Density of silicon oil)/(Weight before immersion/Density of sampled piece)

When a size of the pores in the porous layer is smaller than color material in an image forming liquid, the color material is prevented from entering the pores during printing, thus preventing printing smear. To this end, a preferable average pore size is between 0.08 μm and 0.5 μm, inclusively; a more preferable size is between 0.08 μm and 0.2 μm, inclusively.

The thickness of the porous hydrophilic layer is determined based on a droplet amount of the discharged image forming liquid. Due to capillary action, the micropores in the porous layer allow the attached liquid to permeate in a depth direction, while preventing the liquid from spreading in a horizontal direction of the printing plate material. Controlling the thickness prevents the attached liquid from entering the micropores completely, and thus no liquid left on the surface. In order for printing ink to adhere and endure printing for several tens of thousands times, it is preferable to expose the attached liquid for about 2 μm to 3 μm from the surface. The anchor effect of the micropores differs depending on the thickness of the hydrophilic layer. Thus, the adhesion between the dot and the printing plate material is also taken into account to determine the thickness of the layer.

When discharging the image forming liquid using a high-resolution inkjet recording head having 2,400 DPI, for instance, the droplet amount is 2 pl to 3 pl. A preferable thickness of the hydrophilic layer is between 3 μm and 10 μm, inclusively, so that the dot shape of the droplet does not spread and holds substantially the same droplet diameter at the time of discharge. When the discharged droplet amount increases, however, the hydrophilic layer needs to be thicker; while when the amount decreases, the layer needs to be thinner.

An example material used for such a porous hydrophilic layer includes a hydrophilized polyethylene porous film (e.g., a polyolefin fine porous film “Capacitor” manufactured by Nippon Sheet Glass Co., Ltd.). It is also possible to mix and apply a mixture of a porous aluminum oxide having micropores or a water substance including such an oxide, and porous silica particles, with a component that works as a binder, such as polyvinyl alcohol and the like. Further, a hydrophilic material other than listed above may also be used.

The film base material on which the porous hydrophilic layer is provided, may or may not be roughened.

The printing plate material for direct plate-making of the embodiments of the present invention has the dot control layer provided on the hydrophilic layer. The dot control layer is a layer provided in order to control the dot shape. A configuration of the dot control layer is not limited, as far as the layer has a critical surface tension equal to or lower than a surface tension of the above-described image forming liquid. The critical surface tension of a solid object according to the present invention is measured in a commonly-called Zisman plot method (refer to Kondo, Masatoshi, et al. 2005. Surface Chemistry. p. 189. Maruzen) wherein: 1) a plurality of liquids are prepared, whose surface tensions at a temperature of 25 degrees Celsius are known; 2) a contact angle of each of the liquids and the dot control layer surface is measured at a temperature of 25 degrees Celsius; 3) a relationship between each of the surface tensions and the contact angle is plotted; and 4) a value having a contact angle of 0 is inserted.

The dot control layer can be formed by applying a surfactant, a block copolymer, or a block oligomer to the base material. The surfactant is a substance having hydrophilic and hydrophobic portions in a molecule. The block copolymer herein means a polymer having both hydrophilic and hydrophobic portions in a molecule. The block oligomer means a block copolymer having a low molecular weight. The dot control layer may be formed by dissolving one of the substances above in a solvent and applying the dissolved substance, but the surfactant is preferable in terms of workability in application.

Further, the dot control layer needs to be removed from a non-image portion, in order to ensure dampening water retainability during printing. The dot control layer can be removed by using a solvent that dissolves the dot control layer, such as, an organic solvent, water, and an organic solvent mixed with water. It is preferable to use water as the solvent since water can easily remove the dot control layer, and further dampening water used during printing can be used for the removal. On the other hand, using a non-water-soluble surfactant requires a removal process before printing. Therefore, it is preferable that the dot control layer be water-soluble. A water-soluble surfactant has a good affinity for the hydrophilic layer, thus providing an advantage of forming an even dot control layer without irregularity. It is preferable to use a water-soluble surfactant having a surface tension of 20 mN/m or lower in a water solution having 0.1% by weight, since such a surfactant enables the dot control layer to have a critical surface tension of lower than 30 mN/m and allows easy removal of the dot control layer due to its water solubility.

Examples of the above-described surfactant include a fluorosurfactant having an alkyl fluoride group, a hydrocarbon surfactant having an alkyl group, and the like. Since the image forming liquid is generally lipophilic, however, it is preferable that the surface tension of the dot control layer not only be hydrophobic but lipophobic. Thus, the fluorosurfactant is particularly preferable since the surfactant is capable of forming a layer having a lower surface tension. An example of the fluorosurfactant includes “Surfron” manufactured by Seimi Chemical Co., Ltd., the surfactant having a surface tension of 17 mN/m in a water solution having 0.1% by weight.

As described above, on the direct-made printing plate according to the embodiments of the present invention, the dot control layer provided on the surface of the printing plate material allows the image forming liquid discharged during plate-making to adhere to the printing plate material having a wide contact angle, and allows the dot to hold a small dome shape without spreading. Thereby, the direct-made printing plate is capable of maintaining high resolution. In order to improve adhesion of the image forming liquid to the printing plate material for direct plate-making, however, it is preferable that the surface of the printing plate material have an appropriate wettability with respect to the image forming liquid. In order for the image forming liquid not to spread and to maintain adhesion, a preferable critical surface tension of the dot control layer is between 30% and 95%, inclusively, of the surface tension of the image forming liquid; a more preferable critical surface tension is between 30% and 90%, inclusively; and a further more preferable critical surface tension is between 50% and 80%, inclusively. For instance, when an ultraviolet hardening resin having a surface tension of substantially 34 mN/m is used as the image forming liquid, a balance between the dot shape and adhesion is particularly excellent with a critical surface tension of the dot control layer of substantially 20 mN/m. A preferable contact angle of the image forming liquid with respect to the surface of the printing plate material is between 20 degrees to 70 degrees, inclusively; a more preferable contact angle is between 30 degrees and 70 degrees, inclusively; and a further more preferable contact angle is between 40 degrees and 65 degrees, inclusively. Depending on a surface condition and the like, however, the surface tension range does not need to be as described above.

It is preferable that the dot control layer have a thickness that does not affect the surface shape of the above-described roughened base material, roughened hydrophilic layer, and porous hydrophilic layer.

2. A Manufacturing Method of the Printing Plate Material for Direct Plate-Making:

Although any preferred method may be employed for manufacturing the printing plate material for direct plate-making according to the embodiments of the present invention without affecting the effectiveness thereof, a preferable method is described below. The printing plate material for direct plate-making of the embodiments of the present invention is basically manufactured in processes for forming a hydrophilic layer on a surface of a film base material having resin or paper and for forming a dot control layer on the hydrophilic layer. As described earlier, it is preferable that the surface of the printing plate material for direct plate-making be roughened or porous. It is thus a preferable manufacturing method is:

A) a method that includes a process for forming the hydrophilic layer on a roughened surface of the film base material having resin or paper, and a process for forming the dot control layer on a surface of the hydrophilic layer, wherein the surface of the printing plate material is roughened by roughening the film base material; or

B) a method that includes a process for forming a roughened hydrophilic layer or a porous hydrophilic layer on a relatively flat film base material having resin or paper, and a process for forming the dot control layer on a surface of the hydrophilic layer, wherein the surface of the printing plate material is roughened at the time when the hydrophilic layer is formed.

Method A) is first described below. The roughened surface can be obtained on the film base material in the above-described method. Subsequently, the hydrophilic layer is provided on the base material surface. It is preferable to provide a photocatalytic hydrophilic layer as the hydrophilic layer. In this case, a protective layer needs to be provided in order to keep the film base material from a decomposing reaction caused by the photocatalyst. It is preferable to form the protective layer before providing the photocatalytic hydrophilic layer in terms of ease of processing. The protective layer can be formed by applying and drying a variety of inorganic coating agents, inorganic coating materials, and the like. It is preferable to form the photocatalytic hydrophilic layer by applying to and drying on a surface of the protective layer, an inorganic coating agent having photocatalysts dispersed therein. Using the inorganic coating agent of the same kind as used as the protective layer has an advantage of improving the adhesion.

The photocatalytic hydrophilic layer can induce hydrophilization, or can be hydrophilized, when being exposed to an active light. Hydrophilization may be performed at any stage. It is preferable, for example, to hydrophilize the photocatalytic hydrophilic layer before providing the dot control layer, since, when the dot layer is formed by using a water-soluble surfactant, such hydrophilization provides a good affinity for the surfactant and thus provides an even dot layer.

Further, when manufacturing needs to be suspended for temporary storage for a certain reason, after the photocatalytic hydrophilic layer is provided and before the layer is exposed to the active light for hydrophilization, hydrophilization may be performed when manufacturing resumes. When the hydrophilic property of the hydrophilic layer declines since the layer was stored for a while after having been hydrophilized, hydrophilization may be performed again when manufacturing resumes.

When the dot control layer is formed by using a non-water-soluble surfactant, a block polymer, or a block oligomer, it is advantageous to hydrophilize the photocatalytic hydrophilic layer after providing the dot control layer. Thereby, the photocatalytic hydrophilic layer before hydrophilization has a good affinity for the non-water-soluble surfactant and the like, thus capable of providing an even dot control layer. Since the water-soluble surfactant is preferable for the dot control layer in terms of workability, however, it is more preferable to hydrophilize the photocatalytic hydrophilic layer before providing the dot control layer.

Subsequently, the dot control layer is formed on the surface of the photocatalytic hydrophilic layer obtained as above. For forming the dot control layer, it is preferable to apply and dry a solvent in which a surfactant, a block polymer, or a block oligomer is dissolved. Using water as the solvent eliminates such a problem as evaporation of an organic solvent and the like, and provides high workability. It is thus preferable to apply the surfactant or the like in a form of a water solution. Further, given solubility in water and viscosity of the solution, it is preferable to use a lower-molecular surfactant. Therefore, it is preferable that the dot control layer be formed of an aqueous surfactant solution.

In this case, a preferable concentration of the solution is between 0.1% by weight and 0.9% by weight, inclusively; a more preferable concentration is between 0.2% by weight and 0.8% by weight, inclusively; and a further more preferable concentration is between 0.4% by weight and 0.6% by weight, inclusively. When the concentration of the solution is lower than 0.1% by weight, the dot control layer surface has an insufficient concentration of a hydrophobic group, and thus the critical surface tension of the dot control layer is not low enough. On the other hand, when the concentration of the solution exceeds 1.0% by weight, an excessive surfactant dissolves in dampening water, thereby causing a problem of decline in a dampening water function.

It is preferable that the hydrophilic layer and the dot control layer be thin enough to have no impact to the surface roughness of the film base material.

The surface of the film base material having resin or paper used in this case may be flat and smooth, thus providing an advantage of eliminating the process for roughening the base material.

Described next below is Method B). An inorganic coating agent that includes no photocatalyst used for forming the protective layer and that has spacer particles added and fully dispersed is applied to and dried on the surface of the film base material having resin or paper. Then, an inorganic coating agent including a photocatalyst is applied to and dried on the base material surface, so as to form the roughened hydrophilic layer. An inorganic coating agent including a photocatalyst and having spacer particles added and fully dispersed therein may be applied to and dried on the film base material provided with the protective layer, so as to form the roughened hydrophilic layer. Further, the inorganic coating agent including no photocatalyst and having the spacer particles fully dispersed therein may be applied to and dried on the surface of the film base material having resin or paper so as to form the protective layer. Then, the inorganic coating agent including the photocatalyst and having the spacer particles fully dispersed therein may be applied to and dried, so as to form the roughened hydrophilic layer.

Forming the dot control layer in the above-described method on the hydrophilic layer obtained as above can provide the printing plate material for direct plate-making having a roughened surface.

Further, a material, such as “Olefin Primer” manufactured by Takebayashi Machinery Corp., and the like, can be used to remove dirt, dust, and oil from the surface of the film base material having resin or paper. After being dried, the film base material is applied with an adhesive for polyethylene, such as an adhesive for PE/PP “FRONT#108” manufactured by the company above. Then, a hydrophilized polyethylene porous film is pasted thereon and fixed to practical strength. Thereby, a porous hydrophilic layer can be formed.

Subsequently, the dot control layer is formed in the above-described method, and thereby the printing plate material for direct plate-making can be obtained.

In Method B), the surface of the film base material having resin or paper may be flat and smooth or may be roughened. The flat and smooth base material has an advantage of eliminating the process for roughening the base material. The roughened base material has an advantage of allowing the roughened surface of the printing plate material to have a further complex shape.

The above-described manufacturing methods can provide the printing plate material for direct plate-making which is excellent in printability represented as printing durability and dampening water retainability.

3. The Direct-Made Printing Plate of the Present Invention:

The direct-made printing plate can be obtained through a plate-making process, in which an image forming liquid is discharged on a surface of the above-described printing plate material for direct plate-making and a droplet is hardened so as to form an image. The image forming liquid used in the embodiments of the present invention is a liquid having a liquid form when being discharged, being solidified thereafter in a cooling process or a hardening reaction, and forming an image portion. Examples of such an image forming liquid include a photopolymerized resin, a thermoset resin, and the like.

The photopolymerized resin is a compound which is polymerized when being exposed to an active light. The photopolymerized resin may include photopolymerized material, such as a photo-initiator, a booster, and the like; color material; and solvent. The photopolymerized resin is also referred to as a photo-hardening resin. The photopolymerized resin is a mixture of a high-viscosity oligomer and a low-viscosity oligomer or monomer, which is referred to as a reactive reducer. The viscosity of the photopolymerized resin may be controlled according to a mixing ratio. The active light is a light having a light emitting line in a wavelength range to which the resin is sensitive. An ultraviolet hardening resin, for which ultraviolet works as the active light, is particularly preferable in terms of hardening performance and workability. Specific examples of such resin include polyester acrylate, epoxy acrylate, urethane acrylate, and the like. The photo-initiator is an agent that generates an active species, such as a radical and the like, in reaction to the active light, reacts to a photopolymerized functional group of a monomer or oligomer, and then initiates polymerization. The agent using ultraviolet as the active light is preferable from the above-described reasons.

Further, a pigment or a dye as the color material may also be used so as to allow easy inspection of the plate after plate-making. The color material is added in a state dissolved in a solvent selected from, such as, for example, a hydrocarbon, an alcohol, a ketone, an ether alcohol, an ether, an ester, and the like. The color material has a different ultraviolet absorbing property depending on a hue, and thus substantially affects a hardening property of the ultraviolet hardening resin. It is therefore preferable to select a color material that provides high visibility and minimizes an adverse impact on the hardening property. Further, it is necessary to select a color material that does not adversely impact storage stability of the ultraviolet hardening resin (e.g., does not gelate the resin) and that is not affected by monomer decomposition.

The thermoset resin is a resin that does not harden at room temperature and hardens when being heated. The resin is selected from, such as, for example, acrylic, epoxy, and amino-alkyd resins, and a urethane resin using a block isocyanate resin. The thermoset resin hardens in a crosslinking reaction of functional groups of molecules. From a workability viewpoint, it is preferable that the hardening reaction be performed at a temperature range of 120 degrees Celsius to 180 degrees Celsius.

Although the surface tension of the image forming liquid is not particularly specified, a preferable surface tension is between 30 mN/m to 40 mN/m, so as to allow high-speed and stable forming of a droplet supplied from an inkjet recording head. The surface tension of the liquid defined in the embodiments of the present invention can be measured at a temperature of 25 degrees Celsius using contact angle measuring equipment Drop Master 500 manufactured by Kyowa Interface Science Co. The measuring equipment measures a value of static surface tension in a commonly-called pendant drop method, wherein a droplet image is obtained immediately before the droplet drops from a needlepoint and the surface tension is calculated based on the obtained image and liquid density. More specifically, the measuring equipment automatically measures a maximum radius (d) of the pendant drop hanging from the needlepoint, and then calculates the value using surface tension analyzing software (PD-V type).

A preferable viscosity of the image forming liquid is 30 cps or lower, so as to allow high-speed and stable forming of the droplet (the dot) supplied from the inkjet recording head. A more preferable viscosity is between 8 cps and 20 cps, inclusively. An example of such an image forming liquid is an ultraviolet hardening resin of a polyester acrylate type having a surface tension of substantially 34 mN/m. The inkjet recording head may be heated so as to control the image forming liquid to meet the above-described conditions.

4. A Method for Making a Printing Plate:

Although any preferred method may be employed for making a direct-made printing plate according to the embodiments of the present invention without affecting the effectiveness thereof, a preferable method is described below. The printing plate is made by discharging and hardening an image forming liquid on the printing plate material of the embodiments of the present invention, so as to form an image portion. Discharging means spraying the liquid in a form of a droplet and attaching the droplet to the printing plate material. It is preferable to use an inkjet recording head for discharge. As the image forming liquid, a photopolymerized resin that hardens when being exposed to an active light is preferable, as described above. Particularly preferable is an ultraviolet hardening resin whose active light is ultraviolet. Hardening is a reaction where the active light generates an active species, such as a radical and the like, which reacts to a functional group of the resin and increases a molecular weight. When the photopolymerized resin is employed, exposing the discharged liquid to the active light for hardening forms a reinforced image portion.

When the printing plate material for direct plate-making has a photocatalytic hydrophilic layer, the photocatalytic hydrophilic layer may be hydrophilized when the active light is irradiated to the layer during plate-making. Such a printing plate material has an advantage when the printing plate material for direct plate-making is stored for a long period of time after having been manufactured, since the hydrophilic property may decline even though the photocatalytic hydrophilic layer was once hydrophilized. Such a printing plate material has a further advantage of simplifying a process when the photocatalytic hydrophilic layer of the printing plate material for direct plate-making is manufactured without being hydrophilized, since the plate-making process allows hydrophilization of the photocatalytic hydrophilic layer. Particularly, using the ultraviolet hardening resin as the image forming liquid allows hydrophilization along with a hardening process thereof, thus providing a stable hydrophilic property.

In the case above, the active light for hydrophilizing the photocatalytic hydrophilic layer and the active light for hardening the photo-hardening resin may be different. It is preferable, however, to use the same active light to simplify the manufacturing process. The same active light means an active light having a light emitting line that includes a wavelength range to which both the resin and photocatalyst are sensitive.

The method above can provide a high-resolution printing plate material for direct plate-making which is excellent in printability represented as printing durability and dampening water retainability.

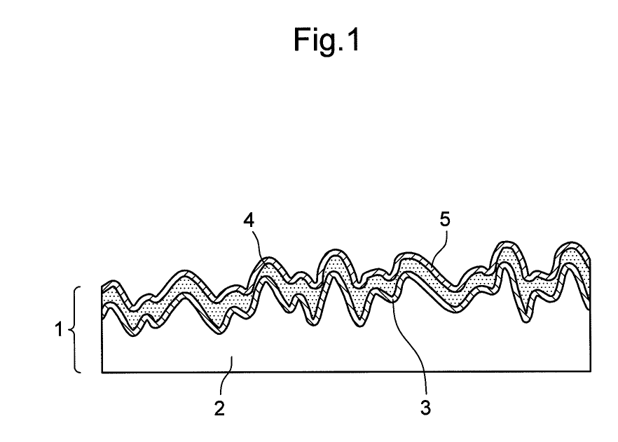

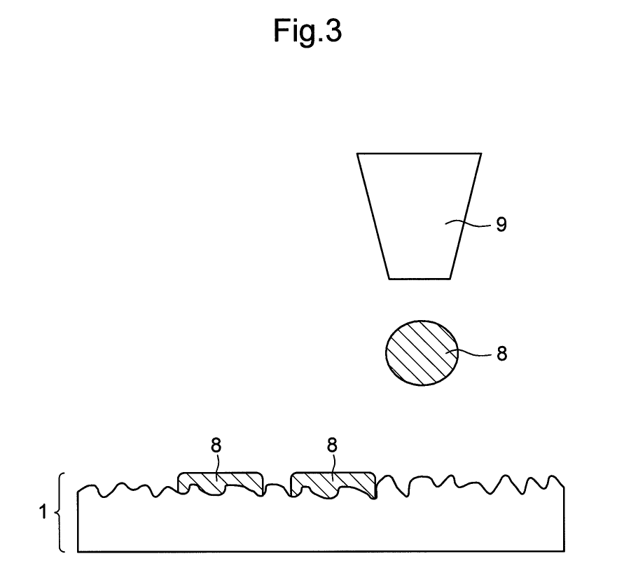

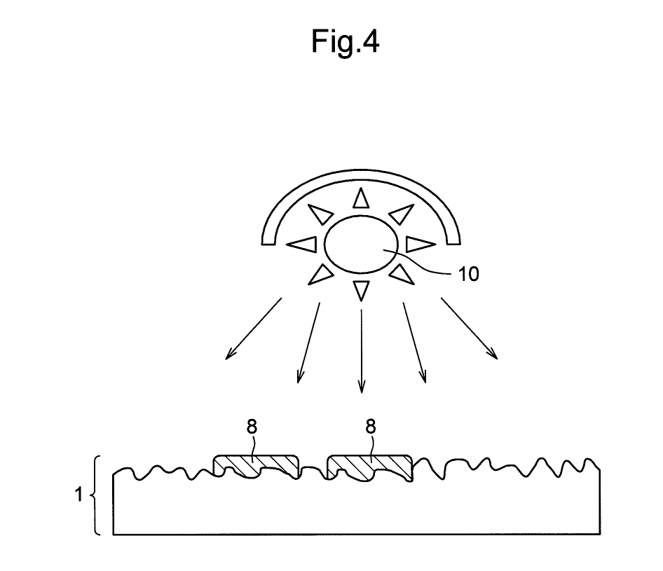

The embodiments of the present invention are explained below with reference to the drawings. The present invention, however, is not limited to the embodiments. FIG. 1 illustrates a first embodiment of the printing plate material for direct plate-making according to the present invention. In FIG. 1, printing plate material for direct plate-making 1 includes film base material 2 having resin, such as PET and the like, and being provided with a roughened surface; protective layer 3 applied to film base material 2; photocatalytic hydrophilic layer 4 applied onto protective layer 3; and dot control layer 5 applied onto photocatalytic hydrophilic layer 4. The method for making the direct-made printing plate using printing plate material for direct plate-making 1 is explained with reference to FIGS. 3 and 4. Shown in FIGS. 3 and 4 are printing plate material for direct plate-making 1; inkjet recording head 9; ultraviolet hardening resin 8, which is polymerized in reaction to ultraviolet light; and ultraviolet light source 10 that hardens the ultraviolet hardening resin adhering to the printing plate material for direct plate-making. As shown in FIG. 3, ultraviolet hardening resin 8 in a form of a droplet is discharged to printing plate material for direct plate-making 1 from inkjet recording head 9 based on data for forming an image portion. A control mechanism (not shown in the drawing) controls inkjet recording head 9 for the droplet discharge and a position of printing plate material for direct plate-making 1, so as to form an image of ultraviolet hardening resin 8, which corresponds to an image portion in printing. Printing plate material for direct plate-making 1, on which the image portion is formed using ultraviolet hardening resin 8, is exposed to ultraviolet light from ultraviolet light source 10. Ultraviolet hardening resin 8 is then hardened, thus completing the plate-making operations. As shown in FIGS. 1 to 3, the embodiments of the present invention provides a relatively simple structure. Provided below are embodiment examples of the present invention.

### EMBODIMENT EXAMPLE 1

A primer manufactured by Matsushita Electric Works, Ltd. is applied to and dried on the surface of flat PET film base material 2, so as to provide a protective layer. A product of Matsushita Electric Works, Ltd., “Frescera-P,” is applied to and dried on the protective layer, so as to provide photocatalytic hydrophilic layer 4. Then, photocatalytic hydrophilic layer 4 is exposed to an ultraviolet light including a wavelength of 350 nm to 400 nm for 3 minutes for hydrophilization, so as to hydrophilize the layer. Subsequently, PET film base material 2 is dipped in and removed from a water solution of a fluorosurfactant (“Surfron” manufactured by Seimi Chemical Co., Ltd.), whose concentration is conditioned at a predetermined level. PET film base material 2 is then dried so as to provide dot control layer 5; and printing plate material for direct plate-making 1 is obtained.

Onto the surface of obtained printing plate material 1, 0.5 cc of ultraviolet hardening resin 8 (a surface tension of substantially 34 mN/m) having a main component of a polyester acrylate polymer is dropped from a pipette, and then spread of a droplet is observed in 5 seconds. Table 1 below shows the results.

TABLE 1

| | | | | | | | |
|---|---|---|---|---|---|---|---|
| Concentration of | 1.00 | 0.80 | 0.60 | 0.40 | 0.20 | 0.10 | 0.03 |
| fluorosurfactant | | | | | | | |
| water solution | | | | | | | |
| (% by weight) | | | | | | | |
| Spread width (mm) | 1.09 | 1.54 | 1.69 | 1.61 | 2.05 | 2.16 | 2.9 |
| in 5 seconds | | | | | | | |
| Contact angle | 63.1 | 60.6 | 62 | 52.6 | 33.8 | 22.9 | 11.9 |
| (degrees) in 5 seconds | | | | | | | |
| Dampening water | Good | Good | Good | Good | Good | Good | Good |
| retainability | | | | | | | |

Based on the spread of ultraviolet hardening resin 8 shown in Table 1, a preferable concentration of the fluorosurfactant is 0.1% or greater by weight. A hydrophilic group in the fluorosurfactant is aligned on a PET film base material 2 side and a perfluoroalkyl group (e.g., a CF₃ group) therein is aligned on an opposite side of PET film base material 2. Thereby, fluorine atoms are aligned on the surface, and thus the surface tension is reduced. It is considered, however, that density of the perfluoroalkyl group varies because of the surfactant concentration in the treatment solution. Meanwhile, when the concentration of the fluorosurfactant is 1.0% or greater by weight, it is confirmed that a large quantity of the fluorosurfactant dissolved in the dampening water during printing declines a dampening water function. This is because an excessive fluorosurfactant unattached to the PET film base material surface is dissolved into the dampening water during printing, thus causing a decline in the dampening water performance. A contact angle in 5 seconds after dropping of ultraviolet hardening resin 8 indicates that the dot spread is contained when the contact angle is between 20 degrees and 70 degrees, inclusively, for reduction of the droplet spread. The spread is further contained when the contact angle is between 30 degrees and 70 degrees, inclusively; and further more contained between 50 degrees and 65 degrees, inclusively.

### EMBODIMENT EXAMPLE 2

A product of Matsushita Electric Works, Ltd., “Frescera-P,” is applied to and dried on the surface of flat PET film base material 2, so as to provide photocatalytic hydrophilic layer 4. Subsequently, PET film base material 2 is dipped in and removed from a water solution of a fluorosurfactant (“Surfron” manufactured by Seimi Chemical Co., Ltd.) having 0.3% by weight. PET film base material 2 is then dried so as to provide dot control layer 5; and printing plate material for direct plate-making 1 is obtained.

Onto the surface of obtained printing plate material 1, 1.0 cc of ultraviolet hardening resin 8 is applied from a pipette, and then spread of the droplet is observed in 5 seconds. Table 2 below shows the results.

### COMPARISON EXAMPLE 1

Similar to Embodiment Example 2, only photocatalytic hydrophilic layer 4 is provided on the surface of PET film base material 2. Then, the spread of the droplet of ultraviolet hardening resin 8 is observed in a similar manner to Embodiment Example 2. Table 2 below shows the results of Embodiment Example 2 and Comparison Example 1.

TABLE 2

| | Embodiment | Comparison |
|---|---|---|
| | Example 2 | Example 1 |
| Dot control layer | Yes | No |
| Droplet spread (mm) | 2.58 | 3.24 |

As shown in Table 2, when dot control layer 5 is provided with the fluorosurfactant, it is confirmed that the dot size of attached ultraviolet hardening resin 8 is small. Namely, it is confirmed that the spread is sufficiently contained, so as to form a high-resolution image portion.

### EMBODIMENT EXAMPLE 3

Hydrophilic layer 4 and dot control layer 5 are provided on PET film base material 2 having a variety of surface roughness, in the method described in the Embodiment Example 1. Thereby, printing plate material for direct plate-making 1 is obtained.

Ultraviolet hardening resin 8 is discharged from the inkjet recording head in a form of a 3-pl droplet to obtained printing plate material 1, in the method described in Embodiment Example 2. Then, ultraviolet having a wavelength of 350 nm to 400 nm is irradiated for 4 seconds, so as to harden the droplet; and then a direct-made printing plate provided with a formed image is obtained. An assessment of the dot adhesion and a dot shape of the printing plate is shown in Table 3.

TABLE 3

| | Ry | Ra | | | Dot size |
|---|---|---|---|---|---|
| | (μm) | (μm) | Peeling | Dot shape | (μm) |
| Embodiment | 3.17 | 0.3 | Large | Fair (protrusion) | 25–30 |
| Example 3 | 6.09 | 0.58 | Medium | Fair (protrusion) | 20–25 |
| | 8.71 | 1.03 | Medium | Fair (protrusion) | 20–25 |
| | 9.24 | 1.21 | Negligible | Good | 20–25 |
| | 9.89 | 1.31 | Negligible | Good | 20–25 |
| | 14.17 | 1.88 | Most negligible | Poor (shape loss) | 25 |
| | 15.08 | 1.42 | Large | Poor (shape loss) | 25 |
| | 22.36 | 3.19 | Small | Poor (shape loss) | 25 |
| | 22.5 | 2.67 | Large | Poor (shape loss) | 25–30 |
| | 23.19 | 3.8 | Medium | Poor (shape loss) | 20 |
| | 38.5 | 4.66 | Large | Poor (shape loss) | 25–30 |
| Comparison | 3.04 | 0.38 | Large | | |
| Example 2 | | | | | |

The adhesion is confirmed by attaching and peeling an adhesive tape to and from an image (2 cm×2 cm) of ultraviolet hardening resin 8, which was discharged and hardened on printing plate material for direct plate-making 1. The peeling test and actual printing test are performed separately and compared against each other. When a result of the peeling test is negligible or less, printing durability of a several ten thousand level is confirmed (i.e., no peeling occurs). The assessment is based on the confirmation method above. The dot shape is determined based on a level of the radial spread (loss of shape) due to the minute unevenness and a sinking level of ultraviolet hardening resin 8 on the uneven surface (whether dot protrusion is large or not). Table 3 shows that peeling is limited, which means the adhesion is good, when Ry (maximum depth) is between 9 μm and 14 μm, and Ra (arithmetic average roughness) is between 1.0 μm and 1.4 μm. Further, the table shows that the dot shape is good when Ry is between 9 μm and 10 μm, and Ra is between 1.0 μm and 1.4 μm. Ry works as a spacer when an ink roller or a blanket contacts during printing, and thus Ry can be expected to achieve an effect to reduce an ink roller pressure or a blanket pressure applied to ultraviolet hardening resin 8 that forms an image. To achieve such an effect, a greater Ry is preferable. It is confirmed, however, that the dot loses shape when Ry and Ra are too great; and that an adhesion area is reduced, thus easily causing peeling, when Ry and Ra are too little.

### COMPARISON EXAMPLE 2

Photocatalytic hydrophilic layer 4 and dot control layer 5 are provided on an aluminum base material (Ra of 0.38 μm; Ry of 3.04 μm), which is used as a base of a conventional PS plate and the like, in a similar manner to Embodiment Example 3. A printing plate material is thus obtained for comparison. Similar to Embodiment Example 3, an image provided with ultraviolet hardening resin 8 is formed on a surface of the printing plate material, and then a printing plate is obtained for comparison. The results of examined adhesion are shown in Table 3. As shown in Table 3, it is confirmed that the comparison example is inferior in adhesion to the printing plate material for direct plate-making of the present invention.

Although the aluminum base material is used as the comparison example, it is considered that a difference in the base material has no impact for comparison of effects of the surface shape of the printing plate material, since the dot does not contact the base material.

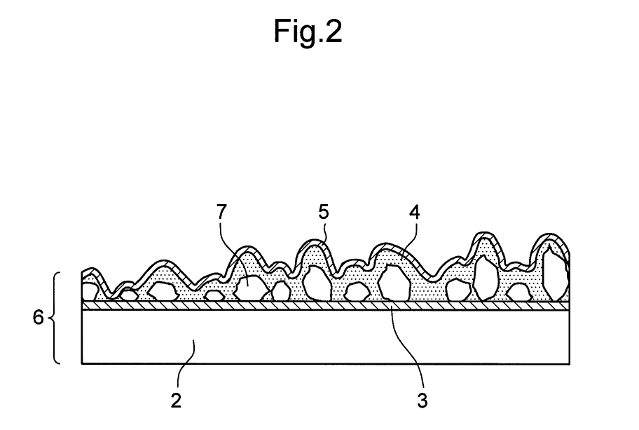

FIG. 2 illustrates a second embodiment of the printing plate material for direct plate-making according to the present invention. FIG. 2 illustrates printing plate material for direct plate-making 6, which includes flat and smooth film base material 2 having resin, such as PET and the like; protective layer 3 applied to film base material 2; photocatalytic hydrophilic layer 4 applied onto protective layer 3; and dot control layer 5 applied onto photocatalytic hydrophilic layer 4. Printing plate material for direct plate-making 6 is different from printing plate material for direct plate-making 1 of the first embodiment, in whether or not intrusions and extrusions on the surface depend on the surface shape of film base material 2. In the first embodiment, the intrusions and extrusions provided on the surface of film base material 2 directly form the surface shape of printing plate material for direct plate-making 1. Meanwhile, printing plate material for direct plate-making 6 of the second embodiment is different in that spacer particles are added to photocatalytic hydrophilic layer 4 so as to form the intrusions and extrusions.

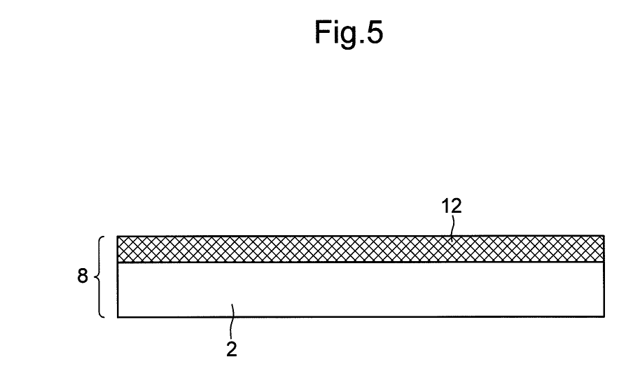

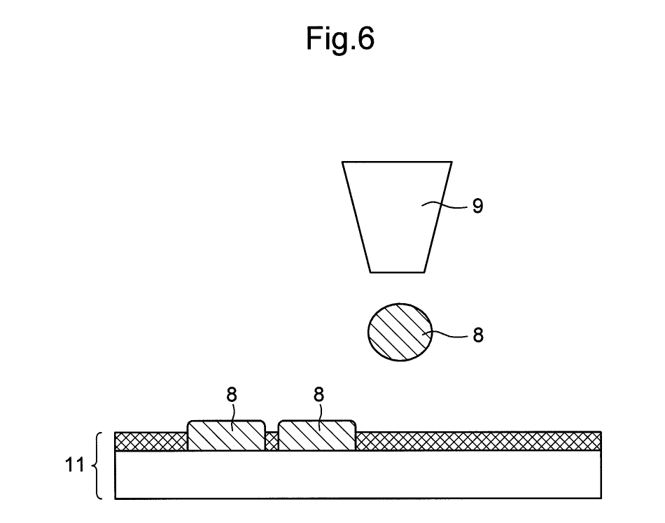

FIGS. 5 and 6 illustrate a third embodiment of the printing plate material for direct plate-making according to the present invention. FIGS. 5 and 6 illustrate printing plate material for direct plate-making 11 that includes PET film base material 2; and polyethylene fine porous film 12 as porous layer 3, the polyethylene fine porous film being hydrophilized, having a porosity of 60% to 80%, and having a thickness of 3 μm to 10 μm. Ultraviolet hardening resin 8 is discharged from inkjet recording head 9.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application Nos. 2006-192335 filed on Jul. 13, 2006 and 2006-285533 filed on Oct. 19, 2006, entire contents of which are expressly incorporated by reference herein.

What is claimed is:

1. A printing plate material onto which an image forming liquid is applied, the printing plate material comprising:
a base material;
a dot control layer that has a critical surface tension equal to or lower than a surface tension of the image forming liquid;
a hydrophilic layer that is provided between said base material and said dot control layer, said hydrophilic layer comprising a photocatalyst that induces hydrophilization when exposed to light; and
a protective layer that is provided between said base material and said hydrophilic layer, said protective haler containing inorganic material.

2. The printing plate material according to claim 1, wherein said base material comprises paper.

3. The printing plate material according to claim 1, wherein said base material comprises resin.

4. The printing plate material according to claim 1, wherein said hydrophilic layer comprises titanium oxide.

5. The printing plate material according to claim 1, wherein said hydrophilic layer has an average thickness in the range of about 0.01 μm to about 1 μm.

6. The printing plate material according to claim 1, wherein said hydrophilic layer is porous, has a porosity in the range of about 60% to about 80%, and has a thickness in the range of about 3 μm to about 10 μm.

7. The printing plate material according to claim 1, wherein said dot control layer comprises a water-soluble material.

8. The printing plate material according to claim 1, wherein a contact angle of said dot control layer and the image forming liquid is in the range of about 30 degrees to about 70 degrees.

9. The printing plate material according to claim 1, wherein said dot control layer has a water-soluble surfactant having a surface tension of about 20 mN/m or lower at a temperature of 25 degrees Celsius in a water solution having 0.1% by weight.

10. The printing plate material according to claim 1, wherein said dot control layer includes a fluorosurfactant.

11. The printing plate material according to claim 1, wherein said base material comprises paper on which one of polyethylene terephthalate treatment and water resistance treatment is provided.

12. The printing plate material according to claim 1, wherein a surface of said base material is roughened.

13. The printing plate material according to claim 1, wherein said hydrophilic layer contains spacer particles, said spacer particles comprising inorganic material that roughens the surface of the printing plate material.

14. The printing plate material according to claim 1, wherein said protective layer contains spacer particles, said spacer particles comprising the inorganic material that roughens a surface of the printing plate material.

15. The printing plate material according to claim 1, wherein a surface of the printing plate material has a surface roughness parameter Ry defined in JIS B0601: 1994 in the range of about 8 μm to about 12 μm, and an average roughness parameter Ra defined in JIS B0601: 1994 in the range of about 1 μm to about 2 μm.

16. A manufacturing method of a printing plate material comprising:
forming a hydrophilic layer on a roughened surface of a base material, the base material comprising one of resin and paper, the hydrophilic layer comprising a photo catalyst that induces hydrophilization when exposed to light; and
forming a dot control layer on a surface of the hydrophilic layer, the dot control layer having a critical surface tension equal to or lower than a surface tension of the image forming liquid to be applied to the printing plate.

17. A manufacturing method of a printing plate material comprising:
forming one of a roughened hydrophilic layer and a porous hydrophilic layer on a surface of a base material, the hydrophilic layer comprising a photo catalyst that induces hydrophilization when exposed to light; and
forming a dot control layer on a surface of the hydrophilic layer, the dot control layer having a critical surface tension equal to or lower than a surface tension of an image forming liquid to be applied to the printing plate.

18. A manufacturing method of a printing plate comprising:
providing, a protective layer on a surface of a base material, the protective layer comprising inorganic material;
providing on the protective layer, a hydrophilic layer containing a photocatalyst that induces hydrophilization when exposed to light;
exposing the hydrophilic layer including the photocatalyst to the light to hydrophilize the hydrophilic layer; and
forming a dot control layer on a surface of the hydrophilic layer.

19. The manufacturing method according to claim 18, further comprising forming the dot control layer by drying a coating film of an aqueous surfactant solution having surfactant in the range of about 0.2% by weight to about 0.8% by weight.

20. A method for making a direct-made printing plate using a printing plate material according to claim 1, the plate-making method comprising:
applying the image forming liquid onto a surface of the dot control layer;; and
hardening the image forming liquid by one of exposing the image forming liquid to the light and heating the image forming liquid.

21. A method for making a direct-made printing plate using a printing plate material according to claim 1, the plate-making method comprising:
applying an image forming liquid including a photopolymerized resin onto a surface of the dot control layer; and
hardening the image forming liquid by exposing the image forming liquid to the light, and, at the same time, hydrophilizing the hydrophilic layer containing the photocatalyst by exposure to the light.
